(19) United States
(12) Patent Application Publication
(10) Pub. No.: US 2011/0072707 A1
(43) Pub. Date: Mar. 31, 2011

(54) HOOK REMOVAL TOOL

(76) Inventor: Graydon Aubrey Shepherd, Auckland (NZ)

(21) Appl. No.: 12/996,142

(22) PCT Filed: Jun. 4, 2009
(86) PCT No.: PCT/NZ09/00095

§ 371 Date: Dec. 3, 2010

(30) Foreign Application Priority Data
Jun. 4, 2008 (NZ) 568818
Dec. 1, 2008 (NZ) 573320
Mar. 19, 2009 (NZ) 575715

(51) Int. Cl. A01K 97/18

(52) U.S. Cl. 43/53.5

(57) ABSTRACT

A hook removal tool primarily for use in the removal of fish hooks. Hooks attached to a line and which are at least partially embedded in a fish or other substrate can be extracted using this tool. The tool includes a body with a handle at or adjacent a proximal end, and having a guide member pivotally connected at or adjacent a distal end. The guide member has at least one guide aperture or slot adapted to engage with the line or hook in such a manner that the line and at least the shank of the hook are able to slide through the aperture or slot. The tool can be slid down the line to the hook and used to dislodge the hook and then to remove the hook out of the fish's mouth.

### FIELD OF THE INVENTION

This invention relates to a hook removal tool, and in particular, but not exclusively to a hook removal tool for removing fishing hooks from fish.

### BACKGROUND

A number of hook removal tools have been developed, for example thin long nosed pliers or tools with sliding loops which can be inserted into a fish's mouth. Such tools have had moderate success, but in general they are time consuming or difficult to use. And they generally require the user to be close to the fish and to have a view down its throat. Some tools have been developed which can be inserted into a fish's throat and twisted to remove the hook and help to get it back out of the throat of the fish.

The use of such tools however often takes a little time, and often results in further injury to the fish. In cases where a fish is to be returned to the water, the time taken to remove a hook, and/or the injuries sustained during hook removal can cause the fish to die. This generally defeats the purpose of returning a fish to the water, for example when undersize fish are returned to help maintain breeding populations.

The removal of hooks from some of the larger game fish can be difficult or even dangerous. It is not uncommon for a fisherman to cut his line to release a large fish in preference to attempting to remove a hook from its throat.

In addition, fish hook removal is often made more difficult because the fish is twisting or moving, or if fishing from a boat that is rocking in rough seas. It would be advantageous to be able to remove hooks from fish in a quick and efficient manner, and in some cases, without having to get too near to the fish.

In this specification unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

### OBJECT

It is therefore an object of the present invention to provide a hook removal tool which will at least go some way towards overcoming the above mentioned problems, or at least provide the public with a useful choice.

### STATEMENTS OF THE INVENTION

Accordingly, in a first aspect, the invention may broadly be said to consist in a hook removal tool for use in the removal of a hook attached to a line from a substrate in which the hook is at least partially embedded, the tool having a body with a handle at or adjacent a proximal end, and having a guide member pivotally connected at or adjacent a distal end, the guide member having at least one guide aperture or slot adapted to engage with the line or hook in such a manner that the line and at least the shank of the hook are able to slide through the aperture or slot.

The guide member can be supported from, and be pivotally connected to, a side of the body of the tool, however, preferably the guide member is supported by, and is pivotally connected to, two arms which extend from the body of the tool.

Preferably the guide member is supported between the two arms of the tool.

Preferably the guide member has a substantially circular profile.

Preferably the guide member is at least partially spherical.

Preferably the body is substantially elongate.

Preferably the or each guide aperture or slot in the guide member is aligned substantially at right angles to the axis of rotation of the guide member.

Preferably the centreline of the or each guide aperture or slot is offset from the axis of rotation of the guide member.

Preferably the guide member is configured such that when a guide aperture or slot of the guide member is engaged with a line or hook, the guide member is able to self adjust to keep the guide aperture or slot at least partially aligned with the section of the line or hook that is in contact with the guide aperture or slot.

Preferably the guide member further includes at least one lead-in slot which is in communication with the or each guide aperture or slot.

Preferably the or each lead-in slot includes bevelled sides providing a wider opening at the periphery of the guide member than where the lead-in slot communicates with the or each guide aperture or slot.

Preferably the width of the or each lead-in slot, where the or each lead-in slot communicates with the or each guide aperture or slot, is less than 0.5 millimetres.

Preferably the opposing sides of the or each lead-in slot, where the or each lead-in slot communicates with the or each guide aperture or slot, are touching or almost touching.

Preferably the opposing sides of the or each lead-in slot, where the or each lead-in slot communicates with the or each guide aperture or slot, are biased toward each other.

Preferably the edges of the or each lead-in slot, where the or each lead-in slot communicates with the or each guide aperture or slot, are substantially not bevelled.

Preferably the hook removal tool is adapted for removing fish hooks from fish.

Preferably the tool is configured such that the sharp end of the hook can be positioned adjacent to a side of the body, within a slot in the body, or between the arms, of the tool.

In a second aspect, the invention may broadly be said to consist in a hook removal tool for use in the removal of a hook attached to a line from a substrate in which the hook is at least partially embedded, the tool having a body with a handle at or adjacent a proximal end, and having a guide aperture at a distal end for receiving the line, and having a lead-in slot which extends from the outer surface of the tool to the guide aperture, the lead-in slot having bevelled sides providing a wider opening at the outer surface of the tool than where the lead-in slot communicates with the guide aperture.

Preferably the guide aperture is adapted to engage with the line or hook in such a manner that the line and at least the shank of the hook are able to slide through the guide aperture.

Preferably the width of the lead-in slot, where the lead-in slot communicates with the guide aperture, is less than 0.5 millimetres.

Preferably the opposing sides of the lead-in slot, where the lead-in slot communicates with the guide aperture, are touching or almost touching.

Preferably the opposing sides of the lead-in slot, where the lead-in slot communicates with the guide aperture, are biased toward each other.

Preferably the edges of the lead-in slot, where the lead-in slot communicates with the guide aperture, are substantially not bevelled.

Preferably the hook removal tool is adapted for removing fish hooks from fish.

Preferably the guide aperture is situated within a guide member which is pivotally connected at or adjacent the distal end of the hook removal tool.

The guide member can be supported from, and be pivotally connected to, a side of the body of the tool, however, preferably the guide member is supported by, and is pivotally connected to, two arms which extend from the body of the tool.

Preferably the guide member is supported between the two arms of the tool.

Preferably the guide member has a substantially circular profile.

Preferably the guide member is at least partially spherical.

Preferably the body is substantially elongate.

Preferably the guide aperture in the guide member is aligned substantially at right angles to the axis of rotation of the guide member.

Preferably the centreline of the guide aperture is offset from the axis of rotation of the guide member.

Preferably the guide member is configured such that when a guide aperture of the guide member is engaged with a line or hook, the guide member is able to self adjust to keep the guide aperture at least partially aligned with the section of the line or hook that is in contact with the guide aperture.

Preferably the tool is configured such that the sharp end of the hook can be positioned adjacent to a side of the body, within a slot in the body, or between the arms, of the tool.

In a third aspect, the invention may broadly be said to consist in a kit of parts for forming a hook removal tool substantially as specified herein when assembled.

The invention may also broadly be said to consist in the parts, elements and features referred to or indicated in the specification of the application, individually or collectively, and any or all combinations of any two or more of the parts, elements or features, and where specific integers are mentioned herein which have known equivalents, such equivalents are incorporated herein as if they were individually set forth.

### DESCRIPTION

Further aspects of the present invention will become apparent from the following description which is given by way of example only and with reference to the accompanying drawings in which:

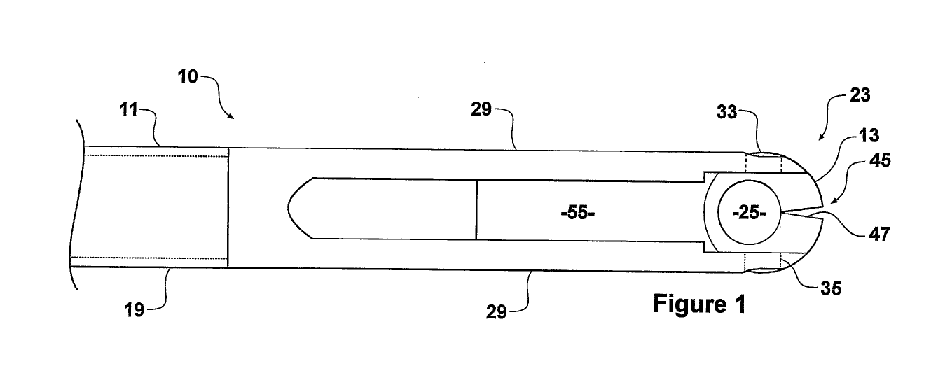

FIG. 1 is a front elevation of a top end of a hook removal tool according to the present invention,

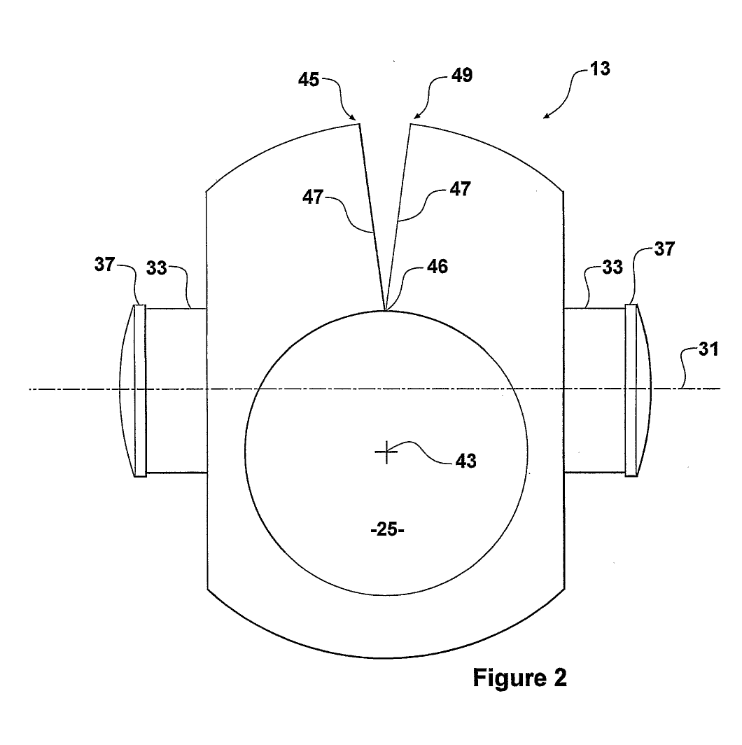

FIG. 2 is a front elevation view of a guide member of the hook removal tool,

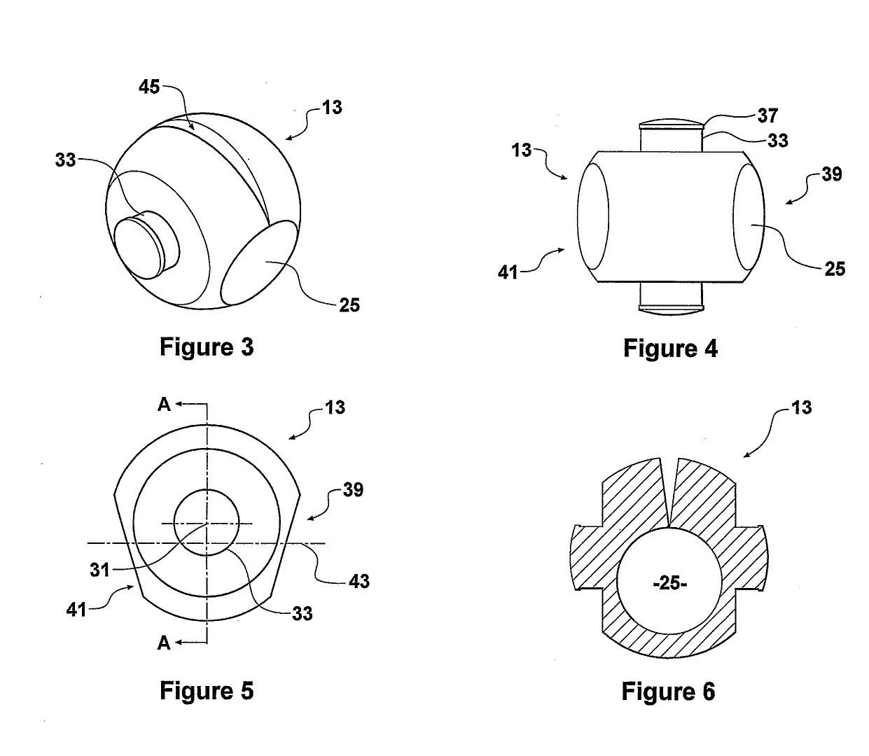

FIG. 3 is a perspective view of the guide member,

FIG. 4 is a bottom plan view of the guide member,

FIG. 5 is a side elevation of the guide member,

FIG. 6 is a cross sectional view AA of the guide member as defined in FIG. 5,

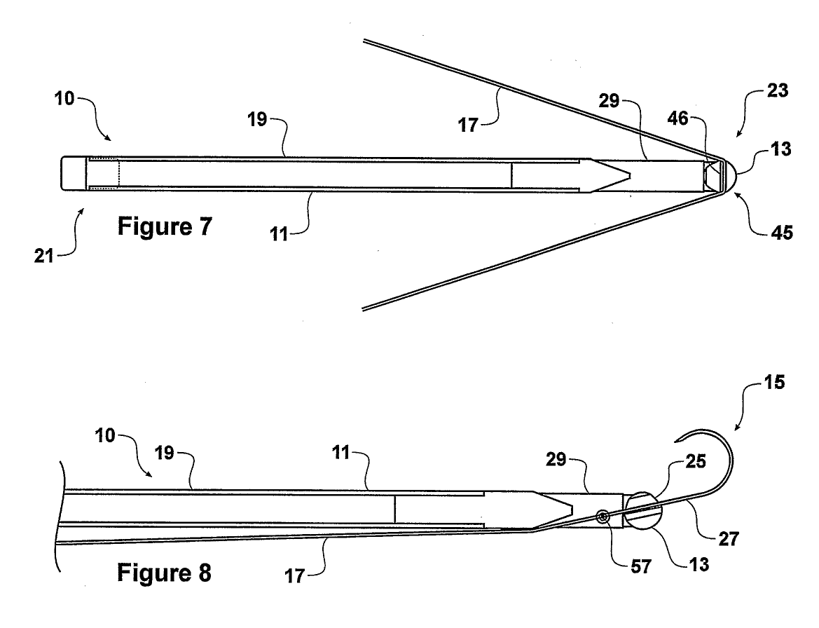

FIG. 7 is a cross sectional side elevation view of the hook removal tool shown being engaged with a line,

FIG. 8 is a cross sectional side elevation view of the hook removal tool shown being passed along the shank of a hook,

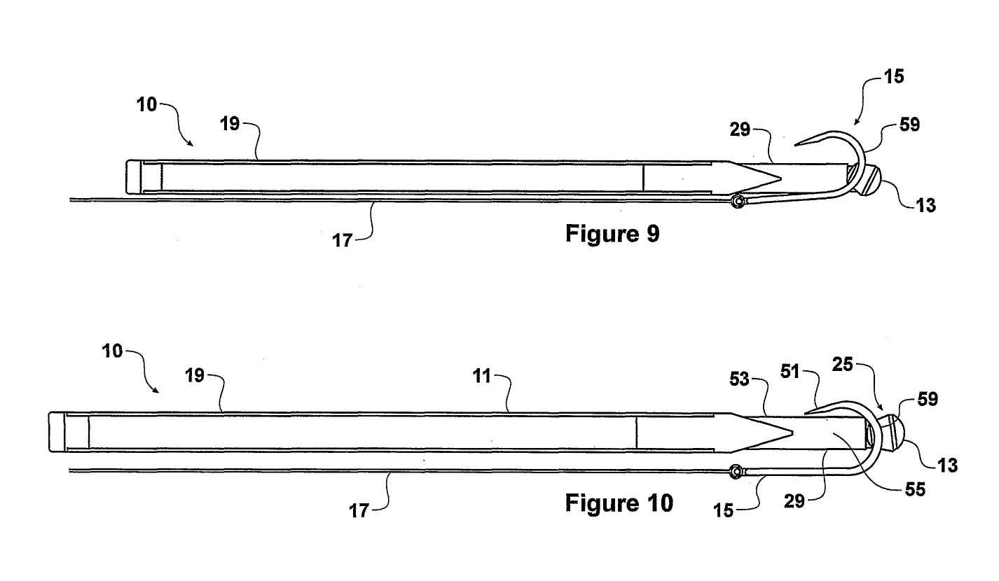

FIG. 9 is a cross sectional side elevation view of the hook removal tool shown being engaged with the hook end of a hook, and

FIG. 10 is a cross sectional side elevation view of the hook removal tool shown engaged with the hook end of a hook and with the sharp end of the hook adjacent to the side or slot of the body of the tool.

With reference to FIGS. 1, and 7 to 10, a hook removal tool (10), is shown having a body (11) and a pivotally connected guide member (13). The tool (10) is for use in the removal of a hook (15) attached to a line (17) from a substrate in which the hook is at least partially embedded. The primary use of the tool (10) is for removing fish hooks from fish, although it is envisaged that the tool (10) could be used for other de-hooking applications.

With reference to FIGS. 7 to 10 the entire tool (10) is shown. It can be seen that in this example the body (11) of the tool (10) is substantially elongate. The tool (10) has a handle (19) at or adjacent a proximal end (21), and the guide member (13) is pivotally connected at or adjacent a distal end (23) of the tool (10). The tool (10) can be oriented in any direction in use, however for the purposes of this description the distal end (23) on which the guide member (13) is connected is sometimes referred to herein as the top of the tool (10). And similarly, the proximal end (21) is sometimes referred to herein as the bottom of the tool (10).

The guide member (13) has a guide aperture (25) which is adapted to engage with the line (17) or hook (15) in such a manner that the line (17) and at least the shank (27) of the hook (15) are able to slide through the guide aperture (25). The guide member (13) can also be referred to as a de-hooking wheel.

The guide member (13) is supported by, and is pivotally connected to, two arms (29) which extend from the body (11) of the tool (10). In this example the guide member (13) is supported between the two arms (29).

In this example the body (11) of the tool (10) can be made from a section of tubing, for example aluminium tubing, and the top end (23) of the tool (10) and the guide member (13) can be made from a plastics material. For general fishing the body (11) can be made from twelve millimetre diameter tubing and the tool (10) need only be about 300 millimetres long. However, for large game fishing the tool (10) could be one to two metres long, and about 25 to 35 millimetres in diameter, to make it safer, stronger and/or more convenient to use. For small fish a six to ten millimetre diameter tool (10) that is only 150 to 200 millimetres long would be suitable.

With reference to FIGS. 2 to 6 the guide member (13) is now described in further detail. It can be seen in FIG. 5 that the guide member (13) has a substantially circular profile. And in FIG. 3 it can be seen that the guide member (13) is at least partially spherical in shape. The ends of the arms (29) are also rounded with a curvature that matches the profile of the guide member (13). This gives the top end (23) of the tool (10) a substantially rounded profile making it easier to insert into a fish's mouth or throat.

The guide member (13) is adapted to pivot about an axis of rotation (31), refer to FIGS. 2 and 5. The guide member (13) includes two stub axles (33), one on either side of the member (13) and each aligned with the axis of rotation (31). The stub axles (33) are configured to mate with corresponding bores (35) in the arms (29). The end of each stub axle (33) is provided with a raised ridge (37). To assemble the tool (10), the guide member (13) is placed between the two arms (29) with the stub axles (33) aligned with the bores (35). The arms (29) are then snapped onto the axles (33) causing the ridges (37) to pass through the bores (35). The ridges (37) then help to prevent the axles (33) being withdrawn from the bores (35) and therefore help to hold the tool (10) together.

In this example the guide aperture (25) is in the form of a cylindrical hole or bore which extends from the front (39) of the guide member (13) to the back (41). FIGS. 2 and 5 show a centreline (43) of the guide aperture (25). It can be seen that the guide aperture (25), or at least its centreline (43), is aligned substantially at right angles to the axis of rotation (31) of the guide member (13). It can also be seen that the centreline (43) of the guide aperture (25) is offset from the axis of rotation (31) of the guide member (13) by a short distance.

With reference to FIGS. 7 to 10 it can be seen that the guide member (13) is configured such that when the guide aperture (25) is engaged with a line (17) or hook (15), the guide member (13) is able to self adjust, or rotate, to keep the guide aperture (25) at least partially aligned with the section of the line (17) or hook (15) that is in contact with the guide aperture (25).

The guide member (13) includes a lead-in slot (45) which is in communication with the guide aperture (25). The lead-in slot (45) includes bevelled sides (47) providing a wider opening (49) at the periphery of the guide member (13) than where the lead-in slot (45) communicates with the guide aperture (25).

In this example, the opposing sides (47) of the lead-in slot (45), where the lead-in slot (45) communicates with the guide aperture (25), are touching or almost touching. The maximum distance between the opposing sides (47) at this location should be no more than about 0.5 millimetres or a typical fishing line could pass back out through the lead-in slot (45) too easily. The sections of the opposing sides (47) of the lead-in slot (45), that are touching or almost touching, can be called lips (46) of the lead in slot (45). Preferably the lips (46), and/or the opposing sides (47), are biased toward each other.

It can be seen in the figures that the edges of the lead-in slot (45), where the lead-in slot (45) communicates with the guide aperture (25), are substantially not bevelled. Such a configuration makes it easier to pass the line (17) into the guide aperture (25) than it is to remove the line (17) from the guide aperture (25). This makes the tool (10) simpler to use as it is less likely to become disconnected from the line (17) when in use.

FIG. 10 shows that the tool (10) is configured such that the sharp end (51) of the hook (15) can be positioned adjacent to a side (53) of the body (11), or edge of an arm (29), of the tool (10). While not shown pictorially, if the guide member (15) rotates a little further, and/or if the hook (15) is a little more hooked, the sharp end (51) of the hook (15) can be positioned within a slot or cavity (55) in the body (11), or between the arms (29), of the tool (10).

The tool (10) can be used as follows to remove a hook from a substrate, or to remove a fishing hook from a fish.
1) The tool (10) is engaged with the line (17) on which the hook (15) is attached by placing the line (17) into the lead-in slot (45)—refer to FIG. 7 By tensioning the line (17) it can be caused to pass by the lips (46) of the lead-in slot (45) and into the guide aperture (25). The tool (10) is preferably engaged with the line (17) between the hook (15) and any other hardware attached to the line (17), for example sinkers or swivels.
2) The tool (10) can then be slid along the line (17) toward the hook (15). Tension in the line (17) can help to ensure that the guide member (13) self adjusts or swivels to ensure that the guide aperture (25) is substantially, or at least partially, aligned with the line (17).
3) Since the guide aperture (25) is sized to accommodate the eye end (57) of the hook (15), the tool (10) can be slid from the line (17), past the eye end (57), and down the shank (27) of the hook (15)—refer to FIG. 8.
4) Then the tool (10) can be pushed further along the hook (15) until the guide member (13) is bearing against the hook end (59) of the hook (15), or at least until the guide member (13) is bearing against any remaining bait on the hook (15)—refer to FIG. 9. At this stage further pushing of the tool (10) into the mouth or throat of the fish, and/or jerking or bumping the tool (10), can dislodge, or disengage, the hook (15) from the mouth or throat of the fish.
5) Once the hook is freed from the tissue of the fish, the guide member can pivot a little more and can travel a little further along the hook (15) toward its sharp end (51)—refer to FIG. 10. At this stage, the sharp end (51) of the hook (15) is positioned adjacent to the side (53) of the body (11), or is positioned within the slot or cavity (55) in the body (11), or between the arms (29). And because the sharp end (51) of the hook (15) is essentially shielded by the tool (10) the tool (10) at this stage, the hook (15) can be removed from the fish with little chance of the hook (15) catching or snagging on the fish again.

Alternatively the tool (10) can be attached to a support member or structure as opposed to being hand held. This leaves a hand free to control the fish, which can be useful particularly when de-hooking smaller fish. One hand can be used to control the line (17), and the other hand can be used to hold the fish and to manipulate it as required onto the tool (10) to release it from the hook (27).

Trials using this method have shown that it is possible to align the fish relatively easily to ensure that the tool (10) engages properly with the hook (27), and it is possible to carefully manipulate the fish and to feel the fish being released from the hook (27). When releasing smaller fish this helps in significantly reducing the stress on the fish and improves their chances of survival after being released.

When de-hooking a fish using this method the tool (10) is not jerked or pushed into the fish to release the hook, but rather the fish is pushed further onto the tool (10) to release the hook. Trials have shown that it is possible to feel the hook disengaging from the fish, allowing great control and care to be taken when de-hooking the fish. These trials indicate that the de-hooking procedure can in fact be simpler and more effective, particularly when de-hooking smaller fish, when the tool (10) is used in this way, i.e. when it is supported or held independently and not by hand.

The tool (10) can be rigidly attached, or pivotally attached, to the support member or structure. The support member or structure could be a purpose built support, a part of a boat, or any convenient piece of equipment or structure where fish are being caught. The tool (10) can be clamped to the support structure, or attached using fasteners.

One method of attachment that has been trialled is to pivotally attached the tool (10) to the side of a boat, by attaching the tool (10) using a screw which passes though the proximal end (21) of the tool (10) and into a top edge of the boat structure. A pivoting attachment is useful as the tool (10) can be moved easily between a retracted or stowed position and a deployed position in which it can be used to de-hook fish. When returning fish to the water it is convenient to position the distal end (23) of the tool (10) over the water so that a fish can be quickly and easily de-hooked and then be allowed to fall back into the water. But when de-hooking a fish that is to be kept, it may be preferable to position the distal end (23) of the tool (10) over the interior of the boat to reduce the chance of losing the fish after it has been de-hooked.

Mounting the tool (10) onto a kayak, in either a fixed or pivotal manner, could be very useful when fishing from a kayak.

The support member or support structure could include a footplate and an upright member adapted to hold the tool (10). Such a support member could be held firm by placing a foot on the footplate. Alternative support structures could include a tripod assembly, or a stake or pole that can be pushed into the ground.

### Variations

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

In the example described above the tool (10) includes an elongate body, for example a body formed from a section of tubing. However in an alternative configuration, the body (11) could be in the form of an oval handle shape, or a range of other shapes.

In the example described above the guide member (13) is supported between two arms (29). However, optionally the guide member can be supported from, and be pivotally connected to, a side of the body of the tool (10).

In the example above the guide aperture (13) is described as a cylindrical hole or bore, however the guide aperture (13) could be a guide slot having a range of profiles.

In the example described above the guide member (13) has one guide aperture or slot and one lead in slot, however, in an alternative configuration, the guide member (13) could have more than one of each of these.

The guide member (13) or “de-hooking wheel” could alternatively take the form of a swinging arm or stirrup arrangement instead of a wheel. The lead-in slot could extend to the guide aperture from a side of the arm or wheel.

In the example shown and described, the tool (10) has an elongate and substantially straight body (11) which essentially acts as the handle of the tool also. In a variation, the tool (10) could include a handle which extends away from the centreline of the body (11), and/or a substantially circular handle which is concentric with the body (11). Such variations could be useful to improve the control that the user has over the tool (10). Improved control may be an advantage particularly when de-hooking larger fish, for example sharks which can tend to writhe or twist.

### DEFINITIONS

Throughout this specification the word “comprise” and variations of that word, such as “comprises” and “comprising”, are not intended to exclude other additives, components, integers or steps.

### ADVANTAGES

Thus it can be seen that at least the preferred form of the invention provides a fishing apparatus that can quickly and reliably remove hooks from the mouths and throats of different sizes and species of fish with little chance of “re-snagging” the fish during the removal process.

The tool is relatively easy to use and the removal procedure is relatively gentle on the fish.

The chances of a small or undersize fish surviving a hook removal, especially when the hook is deeply embedded, are improved using this tool. This is advantageous in helping to maintain breeding stocks and for the environment.

Using this tool, fish such as barracuda, sharks, stingrays, or poisonous fish can be de-hooked from a distance without having to get too close to the fish where it can be dangerous. There is a reduced need to cut traces and to lose hooks if a dangerous fish is caught.

And since the line can be captured within the guide member (13) during the de-hooking process, the tool (10) can be used to manipulate the orientation of the fish prior to de-hooking. This feature can be used to reduce the possibility that a larger fish, for example a shark, could lunge toward the fisherman. The tool (10), could be used to push the nose end of the fish away by manipulating the line (17) near the fish's mouth.

1-27. (canceled)

28. A hook removal tool for use in the removal of a hook attached to a line from a substrate in which the hook is at least partially embedded, the tool having a body with a handle at or adjacent a proximal end, and having a guide member pivotally connected at or adjacent a distal end, the guide member having at least one guide aperture or slot adapted to engage with the line or hook in such a manner that the line and at least the shank of the hook are able to slide through the aperture or slot.

29. A hook removal tool as claimed in claim 28, wherein the guide member is supported by, and is pivotally connected to, two arms which extend from the body of the tool.

30. A hook removal tool as claimed in claim 28, wherein the guide member is supported between the two arms of the tool.

31. A hook removal tool as claimed in claim 28, wherein the guide member has a substantially circular profile.

32. A hook removal tool as claimed in claim 28, wherein the guide member is at least partially spherical.

33. A hook removal tool as claimed in claim 28, wherein the or each guide aperture or slot in the guide member is aligned substantially at right angles to the axis of rotation of the guide member.

34. A hook removal tool as claimed in claim 28, wherein the centreline of the or each guide aperture or slot is offset from the axis of rotation of the guide member.

35. A hook removal tool as claimed in claim 28, wherein the guide member is configured such that when a guide aperture or slot of the guide member is engaged with a line or hook, the guide member is able to self adjust to keep the guide aperture or slot at least partially aligned with the section of the line or hook that is in contact with the guide aperture or slot.

36. A hook removal tool as claimed in claim 28, wherein the guide member further includes at least one lead-in slot which is in communication with the or each guide aperture or slot.

37. A hook removal tool as claimed in claim 36, wherein the or each lead-in slot includes bevelled sides providing a wider opening at the periphery of the guide member than where the lead-in slot communicates with the or each guide aperture or slot.

38. A hook removal tool as claimed in claim 36, wherein the opposing sides of the or each lead-in slot, where the or each lead-in slot communicates with the or each guide aperture or slot, are biased toward each other.

39. A hook removal tool as claimed in claim 28, wherein the hook removal tool is adapted for removing fish hooks from fish.

40. A hook removal tool as claimed in claim 28, wherein the tool is configured such that the sharp end of the hook can be positioned adjacent to a side of the body, within a slot in the body, or between the arms, of the tool.

41. A hook removal tool as claimed in claim 29, wherein the guide member is supported between the two arms of the tool.

42. A hook removal tool as claimed in claim 37, wherein the opposing sides of the or each lead-in slot, where the or each lead-in slot communicates with the or each guide aperture or slot, are biased toward each other.
